(19) United States
(12) Patent Application Publication
(10) Pub. No.: US 2015/0283852 A1
(43) Pub. Date: Oct. 8, 2015

(54) CUSHIONING WHEEL MEMBER

(71) Applicants: Chung-Hsin Chen, New Taipei City (TW); Yu-Jung Chen, New Taipei City (TW)

(72) Inventors: Chung-Hsin Chen, New Taipei City (TW); Yu-Jung Chen, New Taipei City (TW)

(21) Appl. No.: 14/661,816

(22) Filed: Mar. 18, 2015

(30) Foreign Application Priority Data
Apr. 3, 2014 (TW) 103112572

(51) Int. Cl. B60B 9/04; B60C 7/14

(52) U.S. Cl. CPC B60B 9/04; B60C 7/14; B60C 2007/107

(57) ABSTRACT

A cushioning wheel member has an annular body, an axis and multiple cushioning spokes. The annular body has a through hole defined axially through the annular body. The axis is mounted axially and located centrally in the through hole of the annular body. The cushioning spokes are curved and resilient, are deformed to decentralize the axis with external force applied to the cushioning spokes and recover to centralize the axis with removal of the external force. Each cushioning spoke has two ends, and one end of the cushioning spoke is connected to an inner annular surface of the annular body and the other end is connected to the axis. The cushioning spokes are structurally simple and light and may be deformed when encountering external force or impact and therefore provide excellent press-engaging effect and cushioning effect when installed in an ink ribbon cassette and a light duty carrier.

### BACKGROUND OF THE INVENTION

1. Field of the Invention

The present invention relates to a wheel member, and more particularly to a cushioning wheel member that is capable of serving as a transmission gear in an ink ribbon cassette of a dot matrix printer and providing press-engaging function to an adjacent gear in the ink ribbon cassette. The cushioning wheel member is also capable of serving as a wheel mounted under a light duty carrier such as a baby stroller and providing cushioning function to the carrier.

2. Description of Related Art

A conventional dot matrix printer is loaded with at least one ink ribbon cassette having a transmission mechanism. The transmission mechanism drives an ink ribbon therein to an inking position so that a printing head may press the ink ribbon to hit a paper to be printed on.

With reference to FIG. 8, a conventional ink ribbon cassette has a casing 90, a driver gear 94 and a follower gear assembly. The casing 90 has a cavity 900. The driver gear 94 is mounted rotatably in the cavity 900 of the casing 90. The follower gear assembly is mounted in the cavity 900, is engaged with the driver gear 94 and has a mounting bracket 91, a pressing spring 92, and a follower gear 93. The mounting bracket 91 is mounted slightly pivotally in the cavity 900. The pressing spring 92 is mounted tightly between the mounting bracket 91 and an inner surface of the cavity 900. The follower gear 93 is mounted rotatably in the mounting bracket 91 and is engaged with the driver gear 94. The pressing spring 92 forces the slightly pivotal mounting bracket 91 to press the follower gear 93 to be tightly engaged with the driver gear 94. Thus an inadvertent disengagement between the driver gear 94 and the follower gear 93 can be avoided.

However, the aforementioned combination of the driver gear 94, the mounting bracket 91 and the follower gear 93 is complicated and disadvantages fabrication and production rate of the ink ribbon cassette. Therefore cost of the ink ribbon cassette increases.

Furthermore, a light duty carrier such as a baby stroller has a stroller body and four wheels mounted on the stroller body. However, the wheels are made without cushioning mechanisms. Thus, when the light duty carrier moves on a bumpy ground, vibration is caused by bumps, impacts the light duty carrier, and makes an infant inside the light duty carrier and a user pushing the light duty carrier uncomfortable.

Another carrier with vibration reduction device has been developed. However, the vibration reduction device thereon is structurally complicated and increases the total weight of the carrier, which increases cost the carrier and disadvantages the movement of the carrier.

To overcome the shortcomings, the present invention provides a cushioning wheel member to mitigate or obviate the aforementioned problems.

### SUMMARY OF THE INVENTION

The main objective of the invention is to provide a cushioning wheel member that is capable of serving as a transmission gear in an ink ribbon cassette of a dot matrix printer and providing press-engaging function to an adjacent gear in the ink ribbon cassette. The cushioning wheel member is also capable of serving as a wheel mounted under a light duty carrier such as a baby stroller and providing cushioning function to the carrier.

A cushioning wheel member in accordance with the present invention has an annular body, an axis and multiple cushioning spokes. The annular body has a through hole defined axially through the annular body. The axis is mounted axially and located centrally in the through hole of the annular body. The cushioning spokes are curved and resilient, are deformed to decentralize the axis with external force applied to the cushioning spokes, and recover to centralize the axis with removal of the external force. Each cushioning spoke has two ends, and one end of the cushioning spoke is connected to an inner annular surface of the annular body and the other end is connected to the axis. The cushioning spokes are structurally simple and light and may be deformed when encountering external force or impact and therefore provide excellent press-engaging effect and cushioning effect when installed in an ink ribbon cassette or a light duty carrier.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a first embodiment of a cushioning wheel member in accordance with the present invention;

FIG. 2 is a side view of the cushioning wheel member in FIG. 1;

FIG. 3 is an operational view of the cushioning wheel member in FIG. 2 showing an axis is forced to be eccentric and spokes are deformed;

FIG. 4 is a side view of the cushioning wheel member in FIG. 2, mounted halfway in an ink ribbon cassette of a printer; and

FIG. 5 is a side view of the cushioning wheel member in FIG. 4, mounted completely in the ink ribbon cassette and pressing against a gear;

FIG. 6 is a side view of a second embodiment of a cushioning wheel member in FIG. 1 mounted on a carrier such as a baby stroller;

FIG. 7 is a side view of a third embodiment of a cushioning wheel member in accordance with the present invention; and

FIG. 8 is a side view of conventional gears in accordance with the prior art mounted in an ink ribbon cassette.

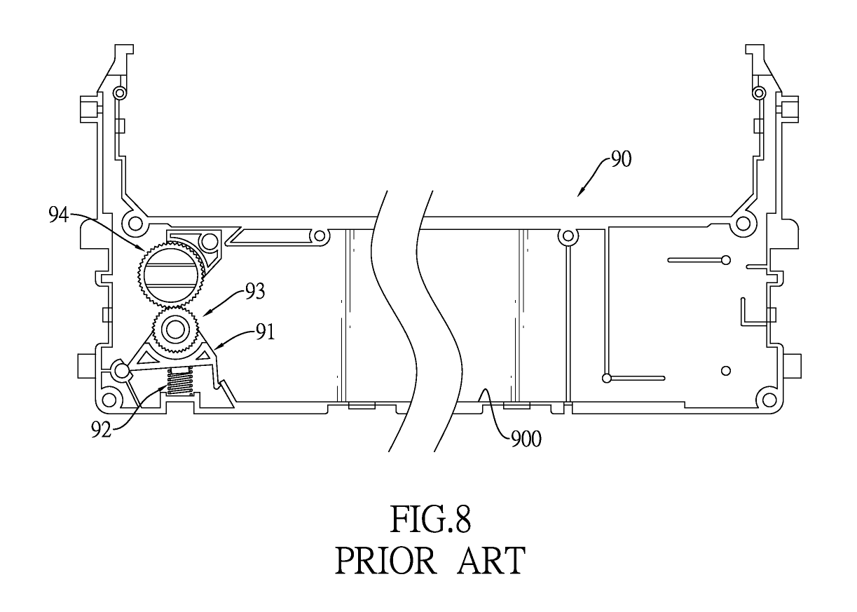

### DETAILED DESCRIPTION OF THE PREFERRED EMBODIMENT

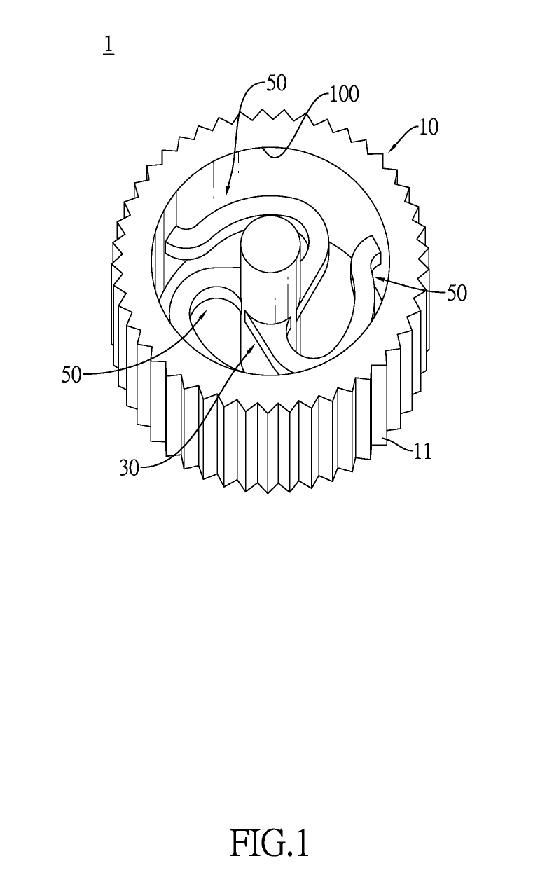

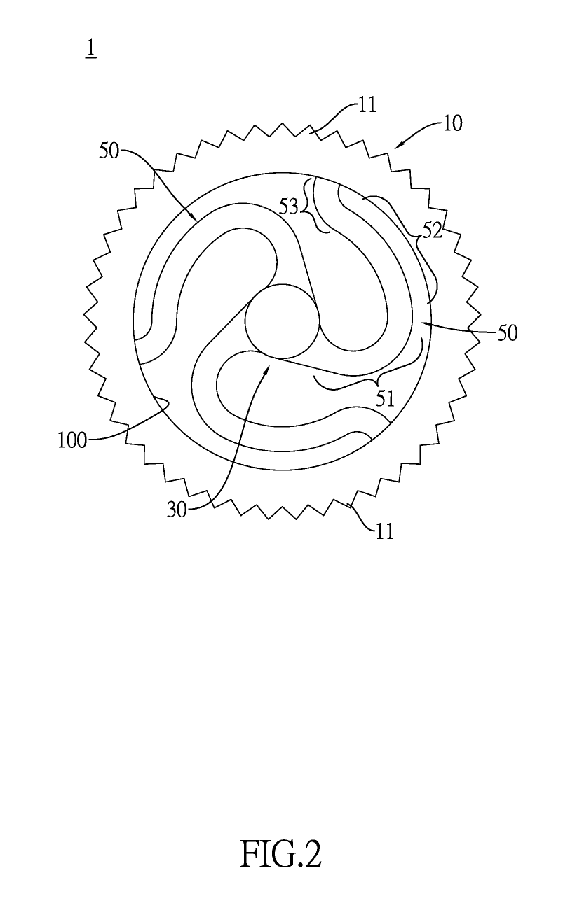

With reference to FIGS. 1 and 2, a first embodiment of a cushioning wheel member 1 in accordance with the present invention is made of plastic comprises an annular body 10, an axis 30 and multiple cushioning spokes 50.

The annular body 10 is made of plastic and has a through hole 100 and multiple engaging elements 11. The through hole 100 is defined axially through the annular body 10. The engaging elements 11 may be teeth and are formed on an outer annular surface of the annular body 10.

The axis 30 is made of plastic and is mounted axially and located centrally in the through hole 100 of the annular body 10.

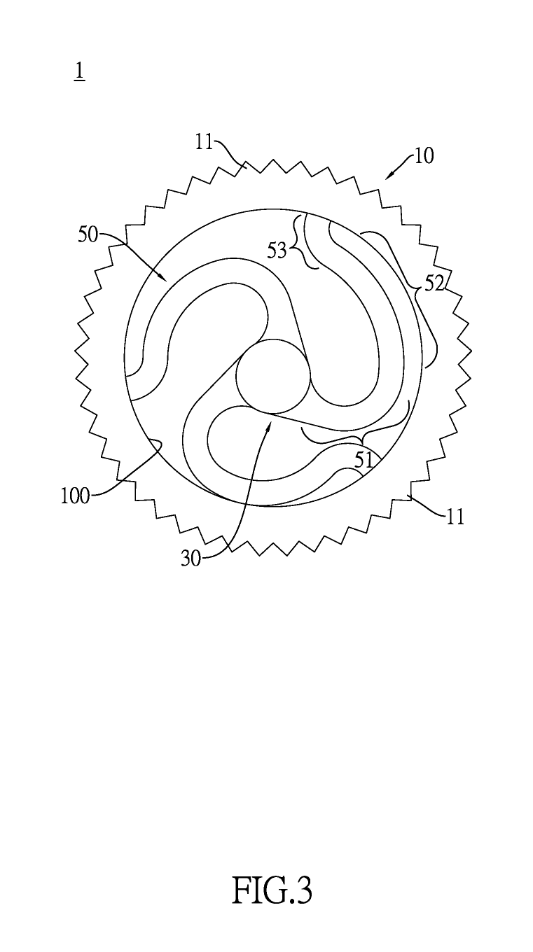

With further reference to FIG. 3, the cushioning spokes 50 may be three in amount, are curved and resilient, are deformed to decentralize the axis 30 with external force applied directly or indirectly to the cushioning spokes 50, and recover to centralize the axis 30 with removal of the external force. Each cushioning spoke 50 is made of plastic and has two ends, a first deformable section 51, a second deformable section 52 and a third deformable section 53. One end of the cushioning spoke 50 is connected to an inner annular surface of the annular body 10 and the other end is connected to the axis 30.

The first deformable section 51 is curved and connected to the axis 30.

The second deformable section 52 is curved and is formed on and protrudes from the first deformable section 51.

The third deformable section 53 is curved, is formed on and protrudes from the second deformable section 52 and is connected to the inner annular surface of the annular body 10.

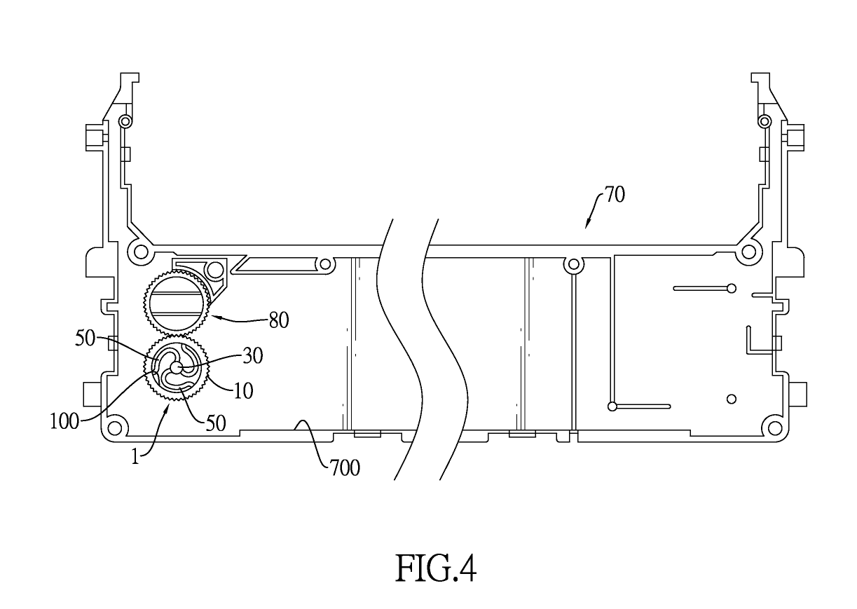

With further reference to FIG. 4, the cushioning wheel member 1 serves as a follower gear and is mounted halfway in a cavity 700 of an ink ribbon cassette 70, and the axis 30 is centralized in the through hole 100 of the annular body 10 without external force.

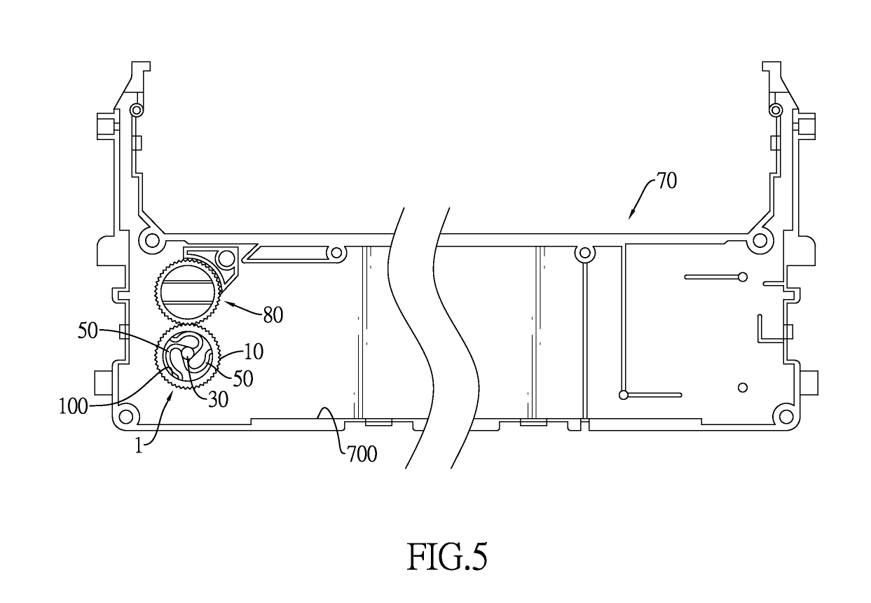

With further reference to FIG. 5, when the cushioning wheel member 1 is completely mounted in the ink ribbon cassette 70, the axis 30 is mounted in a mounting hole in the ink ribbon cassette 70 and the annular body 11 is pressed tightly against a driver gear 80 mounted in the cavity 700 of the ink ribbon cassette 70. A distance between an axis of the driver gear 80 and the axis 30 of the cushioning wheel member 1 is smaller than a total length of two radiuses of the driver gear 80 and the cushioning wheel member 1. Therefore to install the cushioning wheel member 1 into the ink ribbon cassette 70, a user needs to force and move the axis 30 of the cushioning wheel member 1 to be eccentric relative to the through hole 100 of the annular body 10. The cushioning spokes 50 are deformed due to the user's force and the cushioning wheel member 1 is therefore pressed tightly against the follower gear 80 without being disengaged inadvertently from the driver gear 80.

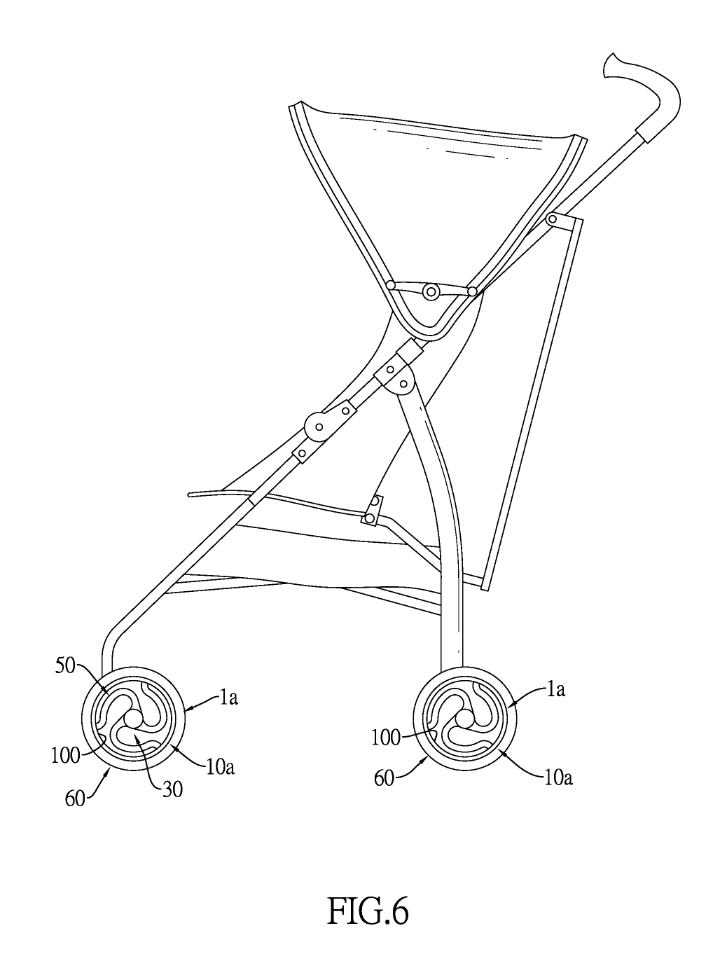

With further reference to FIG. 6, a second embodiment of the cushioning wheel member 1a in accordance with the present invention is made of plastic and serves as a wheel mounted on a carrier such as a baby stroller. Impact from a bumpy ground is absorbed by the cushioning spokes 50 as the carrier moves on the bumpy ground before reaching the axis 30 of the cushioning wheel member 1 so that a stroller body would not be affected by the impact. Thus the cushioning wheel member 1a provides a user pushing the baby stroller and an infant therein with great comfort. The annular body 10a of the cushioning wheel member 1a has an annular groove defined in an outer surface of the annular body 10a to receive an annular resilient element 60 such as a tire. A maximum load of the wheel member 1a is about 7.5 kilograms so that a baby stroller with the four wheel members 1a has a maximum load of about 30 kilograms.

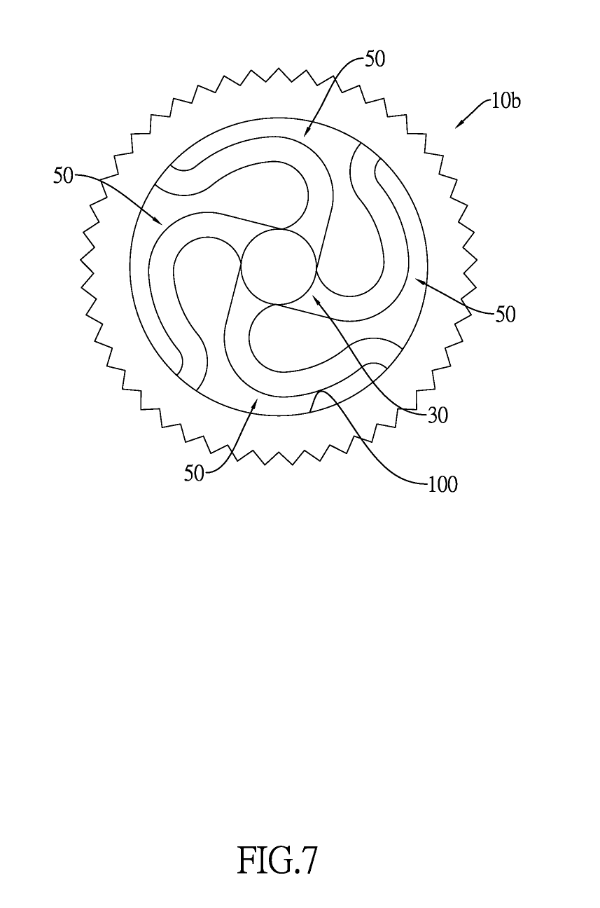

With further reference to FIG. 7, a third embodiment of the cushioning wheel member 1b has four cushioning spokes 50 formed in the through hole 100 of the annular body 10b.

The cushioning spokes 50 are structurally simple and light and may be deformed when encountering external force or impact and therefore provide excellent press-engaging effect and cushioning effect when installed in the ink ribbon cassette and the light duty carrier.

Even though numerous characteristics and advantages of the present invention have been set forth in the foregoing description, together with details of the structure and function of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A cushioning wheel member made of plastic and comprising:
an annular body having a through hole defined axially through the annular body;
an axis mounted axially and located centrally in the through hole of the annular body; and
multiple cushioning spokes being curved and resilient, deformed to decentralize the axis with external force applied to the cushioning spokes and recovering to centralize the axis with removal of the external force, each cushioning spoke having two ends, and one end of the cushioning spoke connected to an inner annular surface of the annular body and the other end connected to the axis;
wherein each cushioning spoke has
a first deformable section being curved and connected to the axis;
a second deformable section being curved and formed on and protruding from the first deformable section; and
a third deformable section being curved, formed on and protruding from the second deformable section and connected to the inner annular surface of the annular body.

2. The cushioning wheel member as claimed in claim 1, wherein the annular body has multiple engaging elements formed on an outer annular surface of the annular body.

3. The cushioning wheel member as claimed in claim 2, wherein the engaging elements are teeth.

4. The cushioning wheel member as claimed in claim 1, wherein an annular groove is defined in an outer surface of the annular body.

5. The cushioning wheel member as claimed in claim 2, wherein an annular groove is defined in an outer surface of the annular body.

6. The cushioning wheel member as claimed in claim 4, wherein an annular resilient element is mounted in the annular groove.

7. The cushioning wheel member as claimed in claim 5, wherein an annular resilient element is mounted in the annular groove.
